(19) United States
(12) Patent Application Publication
(10) Pub. No.: US 2022/0159467 A1
(43) Pub. Date: May 19, 2022

(54) Providing Network Security Using a Network Data Analytic Function

(71) Applicant: AT&T Intellectual Property I, L.P., Atlanta, GA (US)

(72) Inventor: Yaron Koral, Cherry Hill, NJ (US)

(73) Assignee: AT&T Intellectual Property I, L.P., Atlanta, GA (US)

(21) Appl. No.: 17/097,067

(22) Filed: Nov. 13, 2020

(51) Int. Cl. H04W 12/12; H04W 12/00; G06N 20/00

(52) U.S. Cl. CPC H04W 12/1202; G06N 20/00; H04W 12/1204; H04W 12/00512

(57) ABSTRACT

Providing network security using a network data analytic function can include obtaining, at a computing device that executes a network data analytic function, event data that is based on an event stream. The event data can represent events on a cellular network. The event data can be provided to a training module, and the training module can train two or more models associated with the cellular network. The two or more models can include a cell fingerprint that comprises a statistical model of a cell of the cellular network, and a device fingerprint that comprises a statistical model of a device that connected to the cellular network. The two or more models can be output. Additional instances of event data can be provided to a production module, which can determine, using the models, if abnormal activity is detected in the cellular network, and mitigate abnormal activity if detected.

### BACKGROUND

5G cellular networks are designed to support a wide set of applications and devices relative to earlier generation cellular networks. For example, it is expected that some 5G networks may eventually support billions of Internet-of-things (“IoT”) devices. The ability of so many devices to connect to a network widens the attack surface coming from the devices themselves over the 5G network.

Detecting and mitigating attacks coming from such a wide attack vector may be difficult using existing technology. In particular, there does not currently exist any device that is capable of analyzing dynamic new threats coming from so many devices and/or providing timely alerts to other elements that can mitigate such attacks

### SUMMARY

The present disclosure is directed to providing network security using a network data analytic function (“NWDAF”). The network data analytic function is an existing element in the 5G core network and therefore is capable of managing and/or monitoring a huge number of devices that connect to a 5G cellular network. According to embodiments of the concepts and technologies disclosed herein, a cellular network can include a core and one or more cells. Various types of devices can connect to the cellular network. For example, one or more user equipment can connect to the cellular network via the cells and/or other networks or equipment such as, for example, a gateway, router, other customer premises equipment, and/or other device that may connect to the cellular network directly and/or via another network connection such as one provided by the network. The core can include a computing device that can host and/or execute a network data analytic function and/or component thereof such as, for example, a training module, a production module, and a notification and action module.

According to various embodiments of the concepts and technologies disclosed herein, events can be tracked for the devices that connect to the cellular network such as the user equipment and/or the Internet-of-things devices. The events occur in one or more network functions in the 5G Core such as the Access and Mobility Management Function (“AMF”), a 5G Session Management Function (“SMF”), a Policy Control Function (PCF), an Application Function (“AF”), other functions, combinations thereof, or the like, which can operate in the core in some embodiments; or one or more operation, administration, and maintenance functions, which also can operate in the core in some embodiments. The network functions and/or the operation, administration, and maintenance functions can be configured to inject events (or data describing the events) into an event stream. The event stream can be provided to (or accessed by) a data collection module. The data collection module can correspond, in some embodiments, to an API, portal, or other access mechanism associated with the computing device or other device that hosts and/or executes the network data analytic function.

The data collection module can extract, from the event stream, the events and provide, to the network data analytic function (“NWDAF”), event data that can describe the events and/or can include the events from the event stream. In some embodiments, the data collection module can be configured to split the event stream and provide, to the training module, events for training one or more models (e.g., only events associated with normally operating devices and/or network components). Similarly, the data collection module can be configured to provide, to the production module, events for evaluating behavior of devices or network components against the one or more trained models. In some other embodiments, the event stream may not be split by the data collection module.

The training module can obtain the event data and train one or more models on the event data, where the training module can correspond to machine learning algorithms and the models can correspond to one or more statistical representations of one or more devices and/or network components. According to various embodiments of the concepts and technologies disclosed herein, the models can include cell fingerprints, which can model behavior of one or more network components such as the cells; device fingerprints, which can model behavior of one or more devices (e.g., the user equipment and/or the Internet-of-things devices) that connect to the cellular network; device reputations, which can represent reputations of one or more devices (e.g., the user equipment and/or the Internet-of-things devices) that connect to the cellular network; and/or certification data that can represent a certification process associated with one or more devices (e.g., the user equipment and/or the Internet-of-things devices) that connect to the cellular network. These models can be stored by the computing device and/or at other data storage locations.

Once the models exist, the production module can be used to determine if a network device and/or one or more devices (e.g., the user equipment and/or the Internet-of-things devices) that connect to the cellular network are operating abnormally or normally based on instances of event data. In particular, event data can be obtained by the production module and input into the models to determine if the event data represents normal or abnormal activity. If abnormal activity is detected, the network data analytic function (“NWDAF”) can invoke the notification and action module to notify one or more entities (e.g., security personnel, network operators, or the like) of the abnormal activity for remediation and/or other purposes. In some embodiments, the notification and action module can generate output that can include one or more reports that can capture the abnormal behavior. In some other embodiments, the output can correspond to commands for remediating the behavior and can be provided by the network data analytic function to a network management entity or other device for remediation without user or operator intervention. Thus, embodiments of the concepts and technologies disclosed herein can detect and remediate abnormal behavior based on event data.

According to one aspect of the concepts and technologies disclosed herein, a system is disclosed. The system can include a processor and a memory. The memory can store computer-executable instructions that, when executed by the processor, cause the processor to perform operations. The operations can include obtaining, at a computing device that executes a network data analytic function, event data based on an event stream. The event data can represent events on a cellular network. The operations further can include providing, to a training module, the event data; and training, using the training module, two or more models associated with the cellular network. The two or more models can include a cell fingerprint and a device fingerprint. The cell fingerprint can include a statistical model of a cell of the cellular network, and the device fingerprint can include a statistical model of a device that connected to the cellular network. The operations further can include outputting the two or more models.

In some embodiments, the operations further can include splitting, using a data collection module, the event stream into a first portion of the event data and a second portion of the event data. Providing the event data to the training module can include providing the first portion of the event data to the training module. The operations further can include providing, to a production module, the second portion of the event data.

In some embodiments, the operations further can include receiving a new instance of event data from the event stream; providing, to a production module, the new instance of event data; and determining, by the production module and based on the new instance of event data and the two or more models, if abnormal activity is detected in the cellular network. The abnormal activity can be associated with the device that connected to the cellular network or a network component of the cellular network. The operations further can include in response to determining that the abnormal activity is detected, triggering, using a notification and action module, an action.

In some embodiments, the action can include generating, using the notification and action module, a command to remediate the abnormal activity; and providing, using the notification and action module, the command to a network management entity of the cellular network to modify an operation of the cellular network. In some embodiments, the action can include generating, using the notification and action module, a report that represents the abnormal activity; and providing, using the notification and action module, the report to an operator device.

According to another aspect of the concepts and technologies disclosed herein, a method is disclosed. The method can include obtaining, at a computing device including a processor that executes a network data analytic function (“NWDAF”), event data based on an event stream. The event data can represent events on a cellular network. The method also can include providing, by the processor and to a training module, the event data; and training, by the processor and using the training module, two or more models associated with the cellular network. The two or more models can include a cell fingerprint and a device fingerprint. The cell fingerprint can include a statistical model of a cell of the cellular network, and the device fingerprint can include a statistical model of a device that connected to the cellular network. The method also can include outputting, by the processor, the two or more models.

In some embodiments, the device that connected to the cellular network can include a user equipment that connected to the cell of the cellular network. In some embodiments, the device that connected to the cellular network can include an Internet-of-things device that connected to the cellular network via a customer premises equipment that communicates with the cellular network via a network connection. In some embodiments, the event stream can be received from a network function that operates in a core of the cellular network, the network function including a 5G core Access and Mobility Management Function (“AMF”), a 5G Session Management Function (“SMF”), a Policy Control Function (“PCF”), an Application Function (“AF”), other functions, combinations thereof, or the like.

In some embodiments, the event stream can be received from an operation, administration, and maintenance (“OAM”) function that operates in a core of the cellular network. In some embodiments, the method further can include splitting, by the processor and using a data collection module, the event stream into a first portion of the event data and a second portion of the event data. Providing the event data to the training module can include providing the first portion of the event data to the training module. The method also can include providing, by the processor and to a production module, the second portion of the event data.

In some embodiments, the method further can include receiving, by the computing device, a new instance of event data from the event stream; providing, by the processor and to a production module, the new instance of event data; and determining, by the production module and based on the new instance of event data and the two or more models, if abnormal activity is detected in the cellular network. The abnormal activity can be associated with the device that connected to the cellular network or a network component of the cellular network. The method also can include triggering, by the processor and using a notification and action module, an action, in response to determining that the abnormal activity is detected.

In some embodiments, the action can include generating, by the processor and using the notification and action module, a command to remediate the abnormal activity; and providing, by the processor and using the notification and action module, the command to a network management entity of the cellular network to modify an operation of the cellular network. In some embodiments, the action can include generating, by the processor and using the notification and action module, a report that represents the abnormal activity; and providing, by the processor and using the notification and action module, the report to an operator device.

According to yet another aspect of the concepts and technologies disclosed herein, a computer storage medium is disclosed. The computer storage medium can store computer-executable instructions that, when executed by a processor, cause the processor to perform operations. The operations can include obtaining, at a computing device that executes a network data analytic function, event data based on an event stream. The event data can represent events on a cellular network. The operations further can include providing, to a training module, the event data; and training, using the training module, two or more models associated with the cellular network. The two or more models can include a cell fingerprint and a device fingerprint. The cell fingerprint can include a statistical model of a cell of the cellular network, and the device fingerprint can include a statistical model of a device that connected to the cellular network. The operations further can include outputting the two or more models.

In some embodiments, the operations further can include splitting, using a data collection module, the event stream into a first portion of the event data and a second portion of the event data. Providing the event data to the training module can include providing the first portion of the event data to the training module. The operations further can include providing, to a production module, the second portion of the event data.

In some embodiments, the operations further can include receiving a new instance of event data from the event stream; providing, to a production module, the new instance of event data; and determining, by the production module and based on the new instance of event data and the two or more models, if abnormal activity is detected in the cellular network. The abnormal activity can be associated with the device that connected to the cellular network or a network component of the cellular network. The operations further can include in response to determining that the abnormal activity is detected, triggering, using a notification and action module, an action.

In some embodiments, the action can include generating, using the notification and action module, a command to remediate the abnormal activity; and providing, using the notification and action module, the command to a network management entity of the cellular network to modify an operation of the cellular network. In some embodiments, the action can include generating, using the notification and action module, a report that represents the abnormal activity; and providing, using the notification and action module, the report to an operator device. In some embodiments, the event stream can be received from a network function that operates in a core of the cellular network, the network function including a 5G core access and mobility management function or a 5G session management function.

Other systems, methods, and/or computer program products according to embodiments will be or become apparent to one with skill in the art upon review of the following drawings and detailed description. It is intended that all such additional systems, methods, and/or computer program products be included within this description, and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for providing an event stream to a data collection module, according to an illustrative embodiment of the concepts and technologies described herein.

FIG. 3 is a flow diagram showing aspects of a method for training models by a network data analytic function, according to an illustrative embodiment of the concepts and technologies described herein.

FIG. 4 is a flow diagram showing aspects of a method for using event data and one or more models to detect abnormal activity in a cellular network, according to an illustrative embodiment of the concepts and technologies described herein.

FIG. 5 schematically illustrates a network, according to an illustrative embodiment of the concepts and technologies described herein.

FIG. 6 is a block diagram illustrating an example computer system configured to provide network security using a network data analytic function, according to some illustrative embodiments of the concepts and technologies described herein.

FIG. 7 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to providing network security using a network data analytic function. A cellular network can include a core and one or more cells. Various types of devices can connect to the cellular network. For example, one or more user equipment can connect to the cellular network via the cells and/or other networks or equipment such as, for example, a gateway, router, other customer premises equipment, and/or other device that may connect to the cellular network directly and/or via another network connection such as one provided by the network. The core can include a computing device that can host and/or execute a network data analytic function and/or components thereof such as, for example, a training module, a production module, and a notification and action module.

According to various embodiments of the concepts and technologies disclosed herein, events can be tracked for the devices that connect to the cellular network such as the user equipment and/or the Internet-of-things devices. The events can be tracked by one or more network functions such as one or more AMF, PCF, AF, SMF, other function, combinations thereof, or the like, which can operate in the core in some embodiments; or one or more operation, administration, and maintenance functions, which also can operate in the core in some embodiments. The network functions and/or the operation, administration, and maintenance functions can be configured to inject events (or data describing the events) into an event stream. The event stream can be provided to (or accessed by) a data collection module. The data collection module can correspond, in some embodiments, to an API, portal, or other access mechanism associated with the computing device or other device that hosts and/or executes the network data analytic function.

The data collection module can extract, from the event stream, the events and provide, to the network data analytic function, event data that can describe the events and/or can include the events from the event stream. In some embodiments, the data collection module can be configured to split the event stream and provide, to the training module, events for training one or more models (e.g., only events associated with normally operating devices and/or network components). Similarly, the data collection module can be configured to provide, to the production module, events for evaluating behavior of devices or network components against the one or more trained models. In some other embodiments, the event stream may not be split by the data collection module.

The training module can obtain the event data and train one or more models on the event data, where the training module can correspond to machine learning algorithms and the models can correspond to one or more statistical representations of one or more devices and/or network components. According to various embodiments of the concepts and technologies disclosed herein, the models can include cell fingerprints, which can model behavior of one or more network components such as the cells; device fingerprints, which can model behavior of one or more devices (e.g., the user equipment and/or the Internet-of-things devices) that connect to the cellular network; device reputations, which can represent reputations of one or more devices (e.g., the user equipment and/or the Internet-of-things devices) that connect to the cellular network; and/or certification data that can represent a certification process associated with one or more devices (e.g., the user equipment and/or the Internet-of-things devices) that connect to the cellular network. These models can be stored by the computing device and/or at other data storage locations.

Once the models exist, the production module can be used to determine if a network device and/or one or more devices (e.g., the user equipment and/or the Internet-of-things devices) that connect to the cellular network are operating abnormally or normally based on instances of event data. In particular, event data can be obtained by the production module and input into the models to determine if the event data represents normal or abnormal activity. If abnormal activity is detected, the network data analytic function (“NWDAF”) can invoke the notification and action module to notify one or more entities (e.g., security personnel, network operators, or the like) of the abnormal activity for remediation and/or other purposes. In some embodiments, the notification and action module can generate output that can include one or more reports that can capture the abnormal behavior. In some other embodiments, the output can correspond to commands for remediating the behavior and can be provided by the network data analytic function to a network management entity or other device for remediation without user or operator intervention. Thus, embodiments of the concepts and technologies disclosed herein can detect and remediate abnormal behavior based on event data.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

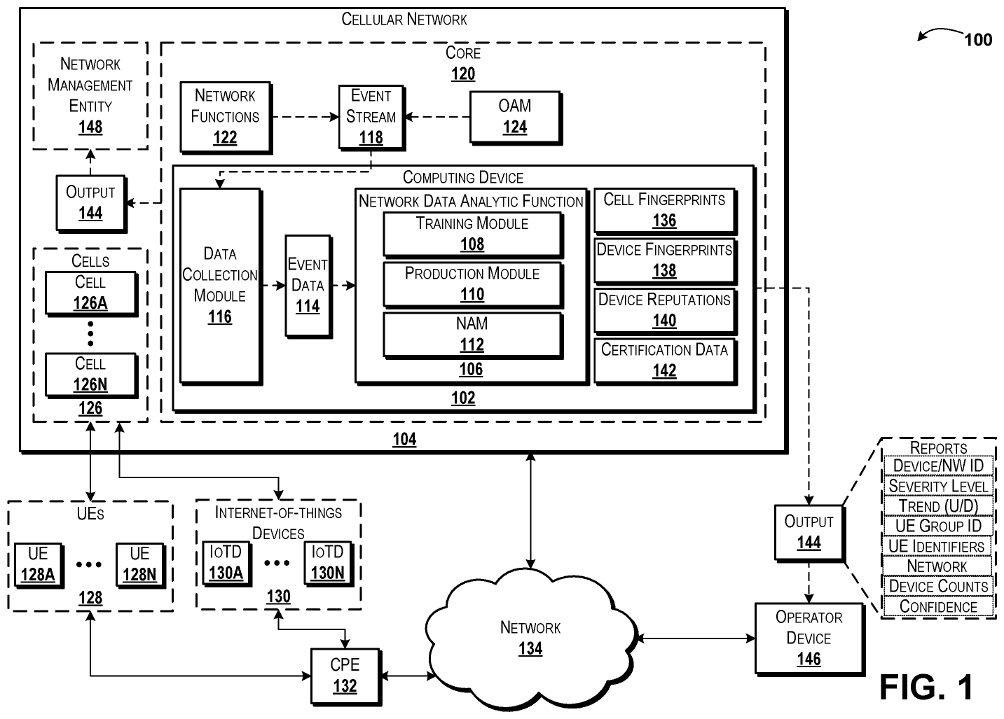

Referring now to FIG. 1, aspects of an operating environment 100 for various embodiments of the concepts and technologies disclosed herein for providing network security using a network data analytic function will be described, according to an illustrative embodiment. The operating environment 100 shown in FIG. 1 includes a computing device 102. The computing device 102 can operate in communication with and/or as part of a cellular network 104, though this is not necessarily the case.

According to various embodiments, the functionality of the computing device 102 may be provided by one or more server computers, desktop computers, laptop computers, other computing systems, and the like. It should be understood that the functionality of the computing device 102 can be provided by a single device, by two or more similar devices, and/or by two or more dissimilar devices. For purposes of describing the concepts and technologies disclosed herein, the computing device 102 is described herein as a server computer. It should be understood that this embodiment is illustrative, and should not be construed as being limiting in any way.

The computing device 102 can execute an operating system (not labeled in FIG. 1) and one or more application programs such as, for example, a network data analytic function 106 or other application program and/or collection of application programs, modules, and/or other software elements. The operating system can include a computer program for controlling the operation of the computing device 102. The network data analytic function 106 can include one or more executable programs that can be configured to execute on top of the operating system to provide various functions as illustrated and described herein.

According to various embodiments of the concepts and technologies disclosed herein, the network data analytic function 106 can be configured to provide traditional functions associated with a network data analytic function 106 such as, for example, management of quality of experience (“QoE”) for the cellular network 104, system optimization for the cellular network 104, configuration monitoring for the cellular network 104, and/or other functions as specified in the 3GPP specification. These functions and/or modules of the network data analytic function 106 are not illustrated separately in FIG. 1 and will not be described in additional detail herein.

According to various embodiments of the concepts and technologies disclosed herein, the network data analytic function 106 can be configured to perform additional operations not typically associated with a network data analytic function. Namely, embodiments of the network data analytic function 106 illustrated and described herein can include security management for the cellular network 104 and/or devices communicating therewith. According to various embodiments of the concepts and technologies disclosed herein, the network data analytic function 106 can include multiple modules that can perform various functionality associated with the network data analytic function 106. Specifically, as shown in FIG. 1, the network data analytic function 106 can include a training module 108, a production module 110, and a notification and action module 112 (labeled “NAM 112” in FIG. 1).

Although the training module 108, the production module 110, and the notification and action module 112 are illustrated as components of the network data analytic function 106 and as executing on the computing device 102, it should be understood that each of these components, or combinations thereof, may be embodied as or in stand-alone devices or components thereof operating as part of or in communication with the cellular network 104, the computing device 102, and/or other devices or entities. As such, the illustrated embodiment should be understood as being illustrative of only some contemplated embodiments and should not be construed as being limiting in any way.

According to various embodiments of the concepts and technologies disclosed herein, the training module 108 can be configured to generate one or more models (e.g., statistical models) of one or more devices associated with the cellular network 104. In particular, according to various embodiments of the concepts and technologies disclosed herein, the training module 108 can be configured to obtain event data 114. The event data 114 can represent various events associated with the cellular network 104. According to various embodiments of the concepts and technologies disclosed herein, the event data 114 can be generated by a data collection module 116. The data collection module 116 can be hosted and/or executed by the computing device 102, in some embodiments, and/or can correspond, in some other embodiments, to an application programming interface (“API”) or other input functionality associated with the computing device 102. It should be understood that this example is illustrative, and therefore should not be construed as being limiting in any way.

The data collection module 116 can be configured to receive an event stream 118, which can correspond to one or more streams of events from one or more monitoring and/or event reporting entities of the cellular network 104. According to various embodiments of the concepts and technologies disclosed herein, the computing device 102 can reside in and/or in communication with a core 120 of the cellular network 104. The one or more monitoring and/or event reporting entities of the cellular network 104 can include, in various embodiments, one or more network functions 122 and/or one or more operation, administration, and maintenance (“OAM”) function 124 (labeled in FIG. 1 as “OAM 124”). It should be understood that this example is illustrative, and therefore should not be construed as being limiting in any way.

The network functions 122 can include, for example, various functions in the core 120 such as, for example, an AMF, a PCF, an SMF, an AF, and/or other functions and/or entities associated with the core 120. According to various embodiments of the concepts and technologies disclosed herein, the core 120 can correspond to a 5G core, but in some embodiments where the core 120 can communicate with other networks and/or sub-networks, it can be appreciated that the network functions 122 can also include 4G (or earlier standard) counterparts such as, for example, mobile management entities (“MMEs”) or other functionality. Because a preferred embodiment of the concepts and technologies disclosed herein provides the functionality illustrated and described herein for a 5G network, it should be understood that the phrase “network functions” as used in the claims can refer only to the 5G functions illustrated and described herein unless a 4G or other function is explicitly recited.

The operation, administration, and maintenance function 124 can include, for example, one or more radio access network (“RAN”) nodes, one or more location based services (“LBS”) nodes and/or location devices, combinations thereof, or the like. Thus, it can be appreciated that the network functions 122 and the operation, administration, and maintenance function 124 can provide the event stream 118 by injecting, into the stream, any events associated with any aspect of the cellular network 104. For example, the event stream 118 can represent and/or include information associated with various events associated with communications between one or more devices associated with one or more network cells 126A-N (hereinafter collectively and/or generically referred to as “cells 126”) and one or more user equipment 128A-N (hereinafter collectively and/or generically referred to as “user equipment 128” and labeled in FIG. 1 as “UE 128”). The word “cell” as used herein with the reference numeral 126 is used generically to refer to any hardware associated with a cell of the cellular network 104 and therefore can include, for example, one or more radios, radio controllers, antennae, etc.

In some other embodiments, the event stream 118 can represent and/or include information associated with various events associated with communications between one or more cells 126 and one or more Internet-of-things devices 130A-N (hereinafter collectively and/or generically referred to as “Internet-of-things devices 130” and labeled in FIG. 1 as “IoTD 130”). The user equipment 128 and/or the Internet-of-things devices 130 can also be configured to communicate with the cellular network 104 via Internet-of-things hubs, gateways, routers, or other customer premises equipment (“CPE”) 132; other network access devices; and/or other devices (labeled “CPE 132” in FIG. 1).

According to various embodiments of the concepts and technologies disclosed herein, the CPE 132 can connect the cellular network 104 via other networks or connections including, but not limited to, wireline and/or wireless connections to the cellular network 104 via a private, public, or other network 134 (labeled “network 134” in FIG. 1), or other networks and/or devices including, but not limited to, the cells 126. Because additional and/or alternative devices can connect to the cellular network 104, it should be understood that these examples are illustrative, and therefore should not be construed as being limiting in any way.

According to various embodiments of the concepts and technologies disclosed herein, the network data analytic function 106 can collect events associated with the cells 126 and/or the user equipment 128 to obtain device events and network events. Thus, it can be appreciated that the event stream 118 can represent events associated with the user equipment 128 and the cells 126 and therefore can include, for example, any information associated with a connection and/or a session (e.g., of a user equipment 128) including, but not limited to, session establishment (e.g., each attachment of one or more user equipment 128 to the cellular network 104 (e.g., via one or more cell 126)), update parameters, tear down events, quality information, combinations thereof, or the like. The event stream 118 also can include events relating to location updates such as, for example, identifying location of one or more user equipment 128, detecting a movement of one or more user equipment 128, other location events, or the like.

According to some embodiments of the concepts and technologies disclosed herein, the event stream 118 provided to the data collection module 116 can be limited to abnormal events associated with the cellular network 104. In some other embodiments, the event stream 118 provided to the data collection module 116 can include all events associated with the cellular network 104 and therefore may not be limited. In some embodiments, all events may be streamed to the data collection module 116 during a training phase, and after training, e.g., in a production phase, all events and/or only abnormal events may be streamed to a data collection module 116. It should be understood that these examples are illustrative, and therefore should not be construed as being limiting in any way.

According to various embodiments of the concepts and technologies disclosed herein, the training module 108 can obtain the event data 114 from the data collection module 116, and use the event data 114 to train one or more models that can represent behavior of one or more user equipment 128 and/or one or more devices or other entities associated with one or more cell 126. According to various embodiments, the training module 108 can include one or more analytic algorithms that can be based on one or more machine learning technologies. The training module 108 therefore can be configured to analyze the event data 114 and to generate one or more models for the user equipment 128 and/or cells 126. According to various embodiments of the concepts and technologies disclosed herein, output from the training module 108 can include one or more cell fingerprints 136 and/or one or more device fingerprints 138. Because additional and/or alternative output is possible and is contemplated, it should be understood that these examples are illustrative, and therefore should not be construed as being limiting in any way.

According to various embodiments of the concepts and technologies disclosed herein, the training module 108 can be configured to create the one or more cell fingerprints 136 and/or one or more device fingerprints 138 by applying one or more machine learning algorithms such as, for example, a linear regression algorithm, a logistic regression algorithm, a decision tree algorithm, a support vector machine (“SVM”) algorithm, a naive Bayes algorithm, a k-nearest neighbors (“kNN”) algorithm, a K-means algorithm, a random forest algorithm, a dimensionality reduction algorithm, one or more gradient boosting algorithms, other algorithms, combinations thereof, or the like. Thus, it can be appreciated that artificial intelligence and/or machine learning can be trained and/or built for the event data 114 to generate one or more cell fingerprints 136 and/or one or more device fingerprints 138. Because other machine learning algorithms can be used, it should be understood that these examples are illustrative, and therefore should not be construed as being limiting in any way.

According to various embodiments of the concepts and technologies disclosed herein, the cell fingerprints 136 can represent cell behavior signatures for one or more of the cells 126. Thus, it can be appreciated that the cell fingerprints 136 can correspond to statistical models for the cells 126 and therefore can be used to approximate and/or predict behavior of one or more cells 126 associated with the one or more cell fingerprints 136. Similarly, the device fingerprints 138 can represent device behavior signatures for one or more of the user equipment 128. Thus, it can be appreciated that the device fingerprints 138 can correspond to statistical models for the user equipment 128 and therefore can be used to approximate and/or predict behavior of one or more user equipment 128 associated with the one or more device fingerprints 138. As such, it can be appreciated that the training module 108 can train one or more models (the cell fingerprints 136) for the cells 126 and one or more models (the device fingerprints 138) for the user equipment 128 during a training phase. It should be understood that these examples are illustrative, and therefore should not be construed as being limiting in any way.

During a production phase, the network data analytic function 106 can use the production module 110 to predict and/or approximate behavior of cells 126 and/or user equipment 128. In particular, the production module 110 can use the cell fingerprints 136 and the device fingerprints 138, as well as other signatures such as, for example, device reputations 140, which can correspond to a device vendor reputation associated with the user equipment 128, and certification data 142, which can correspond to a certification process associated with the user equipment 128. In some embodiments, a device reputation may be defined as being “low” or “poor” if the device type is new in the cellular network 104, if the vendor or manufacturer associated with the device is known to make or sell low quality devices, if the device has been connected to the cellular network 104 for only a short time, combinations thereof, or the like. Because a device reputation can be determined to be high or low in additional and/or alternative manners, it should be understood that these examples are illustrative, and therefore should not be construed as being limiting in any way. The production module 110 can be configured to use, as input, the event data 114 and the models (e.g., one or more of the cell fingerprints 136, the device fingerprints 138, the device reputations 140, and/or the certification data 142) to recognize abnormal behavior of cells 126 and/or user equipment 128 based on events as represented in the event data 114.

In particular, for example, if the event data 114 indicates multiple attaches (e.g., attach events) of a particular user equipment 128 to a cell 126, the behavior of the user equipment 128 may be suspect. Similarly, multiple attaches of an Internet-of-things device 130 to the cellular network 104 may be suspect. In particular, according to various implementations of the cellular network 104, attach events (e.g., attaches of a user equipment 128 to a cell 126 and/or attaches and/or communications of Internet-of-things devices 130 to or via the cellular network 104) may be expected only at power up of the user equipment 128 or Internet-of-things device 130, and/or at other specific times. Thus, multiple attaches or session requests of a user equipment 128 or Internet-of-things device 130 may indicate a malware attack (e.g., an attempt to prompt a denial of service (“DoS”) attack on the cellular network 104). It should be understood that this example is illustrative, and therefore should not be construed as being limiting in any way.

Similarly, if the event data 114 indicates multiple attaches (e.g., attach events) of a number of user equipment 128 and/or Internet-of-things devices 130 to a cell 126 or other device associated with the cellular network 104, the behavior of the user equipment 128 and/or Internet-of-things device 130 may be suspect. In particular, according to various implementations of the cellular network 104, multiple attach events associated with multiple devices (e.g., attaches of multiple user equipment 128 and/or multiple Internet-of-things devices 130 to the cellular network 104) may be expected only at certain times. Thus, if multiple attaches of multiple user equipment 128 and/or multiple Internet-of-things devices 130 may indicate a malware attack (e.g., an attempt to prompt a distributed denial of service (“DDoS”) attack on the cellular network 104, a botnet, or other malicious activity). Because the event data 114 can indicate other types of suspect and/or malicious activity, it should be understood that these examples are illustrative, and therefore should not be construed as being limiting in any way.

It can be appreciated that the event data 114 can be used, in some embodiments, as input for the models (e.g., the cell fingerprints 136, the device fingerprints 138, the device reputations 140, and/or the certification data 142), and that the output can correspond to a statistical representation of abnormal behavior of one or more devices associated with the event data 114. Thus, it can be appreciated that during a production phase, the event data 114 can be analyzed by the production module 110 to identify abnormal behavior associated with one or more devices and/or network element (e.g., the user equipment 128, the Internet-of-things devices 130, and/or the cells 126). It should be understood that this example is illustrative, and therefore should not be construed as being limiting in any way.

The notification and action module 112 can be configured to generate output 144. The output 144 can include reporting associated with the network data analytic function 106, in some embodiments. For example, the output 144 can include one or more reports of abnormal activity associated with the cellular network 104. Thus, the output 144 can be provided to one or more devices such as, for example, an operator device 146, to inform security personnel or other entities of abnormal activity to track and/or to be aware of, events that may trigger responses, predictions of probably security concerns (e.g., an expected future security event and/or an existing buildup to such an attack), or the like. Thus, according to various embodiments of the concepts and technologies disclosed herein, the output 144 can include reports that can include, but are not limited to, information that can be used to identify the abnormal activity, the abnormally acting entity (e.g., user or device), and various aspects of the abnormal activity.

According to various embodiments, the functionality of the operator device 146 may be provided by one or more server computers, desktop computers, laptop computers, mobile telephones, smartphones, tablet computers, other computing systems, and the like. It should be understood that the functionality of the operator device 146 can be provided by a single device, by two or more similar devices, and/or by two or more dissimilar devices. For purposes of describing the concepts and technologies disclosed herein, the operator device 146 is described herein as a personal computing device such as a smartphone, tablet computer, laptop computer, or a desktop computer. It should be understood that this embodiment is illustrative, and should not be construed as being limiting in any way.

In the illustrated embodiment, the reports can include, but are not limited to, a device or network identifier (“Device/NW ID”) associated with a user or device that is acting abnormally; a severity level associated with the abnormal activity (e.g., whether the threat posed by the abnormal activity is high such as, for example, a DDoS or DoS attack, or low such as, for example, a malfunctioning device that is not communicating efficiently); a trend up or trend down associated with the abnormal activity, which can indicate whether the abnormal activity is occurring more frequently or less frequently and becoming more common or less common; a UE group identifier, which can identify a group of user equipment 128 that are associated with the abnormal activity (if any); UE identifiers for user equipment 128 associated with the abnormal activity, which can include, for example, a subscription permanent identifier (“SUPI”), international mobile equipment identity (“IMEI”), international mobile subscriber identity (“IMSI”), other identifiers, or the like; a ratio of monitored network affected by the event versus a portion of the monitored network not affected by the event; a number of devices (e.g., a count) affected by the event; a confidence associated with the abnormal activity; combinations thereof; or the like.

In some embodiments of the concepts and technologies disclosed herein, the output 144 can be provided to a management entity or other entity such as a controller or the like associated with the cellular network 104, which is labeled in FIG. 1 as a network management entity 148. The output 144 can trigger the network management entity 148 in some embodiments to make changes to one or more operational aspects of the cellular network 104, for example, to stop or contain the abnormal activity. Thus, in some embodiments, the network data analytic function 106 can support one or more of the interfaces described in the 3GPP TA 23.288 of registration to events. Thus the output 144 can be provided to the network management entity 148 and/or other devices or entities as part of a subscription, for example, so that analytic reports can be acted on by the cellular network 104.

The network management entity 148 can be configured, for example, to isolate some devices from the cellular network, to reject attach requests associated with some devices, to block communications from some devices, combinations thereof, or the like. Thus, it can be appreciated that the output 144 can be sent to the network management entity 148 to perform operations to stop the abnormal activity that may be detected in accordance with the concepts and technologies disclosed herein. In some embodiments of the concepts and technologies disclosed herein, the operator device 146 can receive the reports illustrated and described herein, and some entity associated with the operator device 146 can trigger various actions as illustrated and described herein. Thus, it should be understood that commands can be generated by the operator device 146 and/or other devices and delivered to the network management entity 148, and/or delivery can be triggered by the operator device 146 or other devices. As such, the illustrated embodiment is merely illustrative and should not be construed as being limiting in any way.

Although the cell fingerprints 136, the device fingerprints 138, the device reputations 140, and the certification data 142 are illustrated as being stored at the computing device 102, it should be understood that these and/or other data illustrated and described herein can optionally be stored at a data storage device. The functionality of the data storage device can be provided by one or more databases, one or more server computers, one or more computers, other computing systems, and the like. It should be understood that this example is illustrative, and therefore should not be construed as being limiting in any way.

Although FIG. 1 illustrates only one network data analytic function 106, it should be understood that various embodiments of the concepts and technologies disclosed herein can include one or more network data analytic functions 106. In particular, in some embodiments, the core 120 can include multiple instances of the network data analytic function 106. In some embodiments, specialized network data analytic function elements can be provided by one or more vendors (e.g., by vendors associated with a particular instance of hardware or the like). As such, the illustrated embodiment is illustrative and should not be construed as being limiting in any way.

In practice, a cellular network 104 can include a core 120 and one or more cells 126. Various types of devices can connect to the cellular network 104. For example, one or more user equipment 128 can connect to the cellular network 104 via the cells 126 and/or other networks or equipment such as, for example, a gateway, router, other customer premises equipment 132, and/or other devices that may connect to the cellular network 104 directly and/or via another network connection such as one provided by the network 134. The core 120 can include a computing device 102 that can host and/or execute a network data analytic function 106 and/or components thereof such as, for example, a training module 108, a production module 110, and a notification and action module 112.

According to various embodiments of the concepts and technologies disclosed herein, events can be tracked for the devices that connect to the cellular network 104 such as the user equipment 128 and/or the Internet-of-things devices 130. The events can be tracked by one or more network functions 122 such as one or more AMF, AF, SMF, other function, combinations thereof, or the like, which can operate in the core 120 in some embodiments; or one or more operation, administration, and maintenance functions 124, which also can operate in the core 120 in some embodiments. The network functions 122 and/or the operation, administration, and maintenance functions 124 can be configured to inject events (or data describing the events) into an event stream 118. The event stream 118 can be provided to (or accessed by) a data collection module 116. The data collection module 116 can correspond, in some embodiments, to an API, portal, or other access mechanism associated with the computing device 102 or other device that hosts and/or executes the network data analytic function 106.

The data collection module 116 can extract, from the event stream 118, the events and provide, to the network data analytic function 106, event data 114 that can describe the events and/or can include the events from the event stream 118. In some embodiments, the data collection module 116 can be configured to split the event stream 118 and provide, to the training module 108, events for training one or more models (e.g., only events associated with normally operating devices and/or network components). Similarly, the data collection module 116 can be configured to provide, to the production module 110, events for evaluating behavior of devices or network components against the one or more trained models. In some other embodiments, the event stream 118 may not be split by the data collection module 116.

The training module 108 can obtain the event data 114 and train one or more models on the event data 114, where the training module 108 can correspond to machine learning algorithms and the models can correspond to one or more statistical representations of one or more devices and/or network components. According to various embodiments of the concepts and technologies disclosed herein, the models can include cell fingerprints 136, which can model behavior of one or more network components such as the cells 126; device fingerprints 138, which can model behavior of one or more devices (e.g., the user equipment 128 and/or the Internet-of-things devices 130) that connect to the cellular network 104; device reputations 140, which can represent reputations of one or more devices (e.g., the user equipment 128 and/or the Internet-of-things devices 130) that connect to the cellular network 104; and/or certification data 142 that can represent a certification process associated with one or more devices (e.g., the user equipment 128 and/or the Internet-of-things devices 130) that connect to the cellular network 104. These models can be stored by the computing device 102 and/or at other data storage locations.

Once the models exist, the production module 110 can be used to determine if a network device and/or one or more devices (e.g., the user equipment 128 and/or the Internet-of-things devices 130) that connect to the cellular network 104 are operating abnormally or normally based on instances of event data 114. In particular, event data 114 can be obtained by the production module 110 and input into the models to determine if the event data 114 represents normal or abnormal activity. If abnormal activity is detected, the network data analytic function 106 can invoke the notification and action module 112 to notify one or more entities (e.g., security personnel, network operators, or the like) of the abnormal activity for remediation and/or other purposes. In some embodiments, the notification and action module 112 can generate output 144 that can include one or more reports that can capture the abnormal behavior. In some other embodiments, the output 144 can correspond to commands for remediating the behavior and can be provided by the network data analytic function 106 to a network management entity 148 or other device for remediation without user or operator intervention. Thus, embodiments of the concepts and technologies disclosed herein can detect and remediate abnormal behavior based on event data 114.

FIG. 1 illustrates one computing device 102, one instance of network functions 122, one operation, administration, and maintenance function 124, two or more cells 126, two or more user equipment 128, two or more Internet-of-things devices 130, one network 134, one operator device 146, and one network management entity 148. It should be understood, however, that various implementations of the operating environment 100 can include zero, one, or more than one computing device 102; one or more than one cellular network 104; zero, one, or more than one instance of network functions 122; zero, one, or more than one operation, administration, and maintenance function 124; one or more cell 126; zero, one, or more than one user equipment 128; zero, one, or more than one or more Internet-of-things devices 130; zero, one, or more than one network 134; zero, one, or more than one operator device 146; and zero, one, or more than one network management entity 148. As such, the illustrated embodiment should be understood as being illustrative, and should not be construed as being limiting in any way.

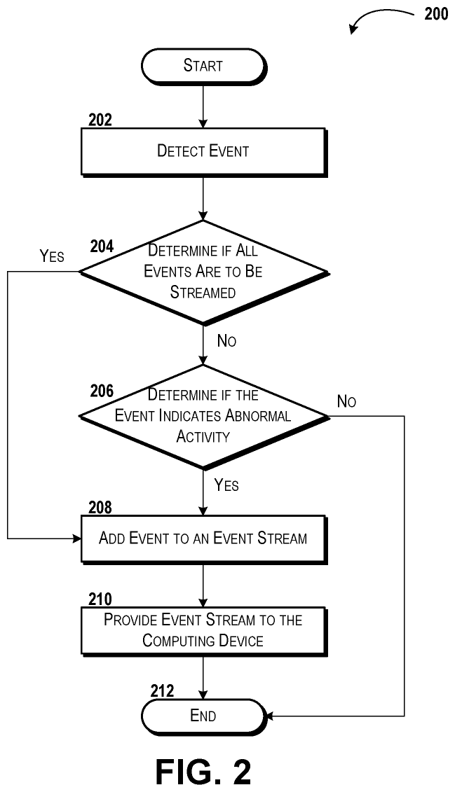

Turning now to FIG. 2, aspects of a method 200 for providing an event stream 118 to a data collection module 116 will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the network functions 122, the operation, administration, and maintenance function 124, and/or the computing device 102, to perform one or more operations and/or causing the processor to direct other components of the computing system or device to perform one or more of the operations.

For purposes of illustrating and describing the concepts of the present disclosure, the method 200 is described herein as being performed by the core 120 of a cellular network 104, for example by execution of one or more network functions 122 and/or one or more operation, administration, and maintenance functions 124. It should be understood that additional and/or alternative devices and/or network nodes can provide the functionality described herein via execution of one or more modules, applications, and/or other software including, but not limited to, the network functions 122 and/or one or more operation, administration, and maintenance functions 124. Thus, the illustrated embodiments are illustrative, and should not be viewed as being limiting in any way.

The method 200 begins at operation 202. At operation 202, core 120 can detect an event. As explained herein, the event detected at operation 202 can correspond, in various embodiments of the concepts and technologies disclosed herein, to establishment of a connection, or a change to a connection, between one or more devices (e.g., a user equipment 128, an Internet-of-things device 130, or other device) and a cellular network 104; a movement of a device relative to the cellular network 104; or other change in a session or communication such as change in quality of service, or the like. As explained above, these and other events can be detected by one or more network functions 122 (e.g., radios, AMFs, AFs, SMFs, etc.) and/or one or more operation, administration, and maintenance functions 124.

From operation 202, the method 200 can proceed to operation 204. At operation 204, core 120 can determine if all events (e.g., the event detected in operation 202) are to be streamed and/or injected into an event stream 118. Alternatively, the core 120 can determine if only abnormal events are to be streamed and/or injected into an event stream 118. Thus, operation 204 can include the core 120 determining that all or only some events are to be added to the event stream 118 illustrated and described herein.

If the core 120 determines, in operation 204, that not all events (e.g., that only abnormal events) are to be added to the event stream 118, the method 200 can proceed to operation 206. At operation 206, core 120 can determine if the event detected in operation 202 indicates some sort of abnormal activity. According to various embodiments, the core 120 can have an extensive event definition library or other threshold definitions that can describe and/or define abnormal activity based on an aspect of events associated with that abnormal activity. As such, operation 206 can correspond to the core 120 determining if the event detected in operation 202 corresponds to abnormal activity.

In a contemplated example embodiment, an attach request associated with a user equipment 128 may be defined as representing abnormal activity if the attach request is received within a defined time interval after a previous attach request. It should be understood that this example is illustrative, and therefore should not be construed as being limiting in any way. Thus, operation 206 can correspond to the core 120 determining if any activity associated with the event detected in operation 202 is abnormal, whether this abnormal activity is associated with a network device (e.g., a cell 126) or a device communicating with the cellular network 104 (e.g., a user equipment 128, an Internet-of-things device 130, and/or other devices). Because an event may be determined to be associated with abnormal activity in additional and/or alternative manners, it should be understood that these examples are illustrative, and therefore should not be construed as being limiting in any way.

From operation 206, the method 200 can proceed to operation 208. The method 200 also can proceed to operation 208 if the core 120 determines, in operation 204, that all events (e.g., not only abnormal events) are to be added to the event stream 118. At operation 208, core 120 can inject an event (or definition or indicator of the event) into the event stream 118. The event stream 118 can correspond to a flow of data that can be streamed from the core 120 to the computing device 102 (e.g., via a data bus or the like), so the event detected in operation 202 can be injected into the event stream 118 so that information that describes the event will be provided to the data collection module 116.

From operation 208, the method 200 can proceed to operation 210. At operation 210, core 120 can provide the event stream 118 to the computing device 102 (or a component thereof such as the data collection module 116). Thus, operation 210 can correspond to the core 120 delivering the event stream 118 to the computing device 102, to the core 120 triggering delivery of the event stream 118 to the computing device 102, and/or to the core 120 otherwise effecting delivery of the event stream 118 to the computing device 102. Because the event stream 118 can be provided to the computing device 102 in additional and/or alternative manners, it should be understood that these examples are illustrative, and therefore should not be construed as being limiting in any way.

From operation 210, the method 200 can proceed to operation 212. The method 200 can end at operation 212.

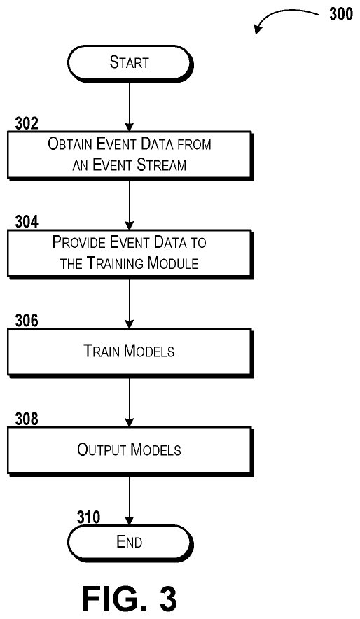

Turning now to FIG. 3, aspects of a method 300 for training models by a network data analytic function 106 will be described in detail, according to an illustrative embodiment. For purposes of illustrating and describing the concepts of the present disclosure, the method 300 is described herein as being performed by the computing device 102 via execution of one or more software modules such as, for example, the data collection module 116 and/or the training module 108. It should be understood that additional and/or alternative devices and/or network nodes can provide the functionality described herein via execution of one or more modules, applications, and/or other software including, but not limited to, the data collection module 116 and/or the training module 108. Thus, the illustrated embodiments are illustrative, and should not be viewed as being limiting in any way.

The method 300 begins at operation 302. At operation 302, the computing device 102 can obtain event data 114 from an event stream 118. Although not illustrated separately in FIG. 3, it can be appreciated that the method 300 can include the data collection module 116 receiving the event stream 118, generating the event data 114, and providing the event data 114 to the network data analytic function 106. As such, operation 302 can include these and/or other operations, in addition to the network data analytic function 106 obtaining the event data 114. As noted above, the event data 114 can describe one or more events associated with the cellular network 104 and therefore can describe events associated with devices connecting to the cellular network 104 (e.g., the user equipment 128 and/or the Internet-of-things devices 130), various devices of the cellular network 104 (e.g., the cells 126), and/or other events as illustrated and described herein. Because the event data 114 can describe additional and/or alternative conditions associated with the cellular network 104 and/or devices communicating therewith and/or thereby, it should be understood that these examples are illustrative, and therefore should not be construed as being limiting in any way.

From operation 302, the method 300 can proceed to operation 304. At operation 304, the computing device 102 can provide the event data 114 obtained in operation 302 to the training module 108. Because the data collection module 116 and the training module 108 can be executed by the same device in some embodiments (e.g., the computing device 102 as illustrated in FIG. 1), it should be understood that operations 302-304 can correspond to the computing device 102 obtaining the event data 114 via an API, portal, service call, or other functionality, and allowing the event data 114 to be accessed by the training module 108. It should be understood that this example is illustrative, and therefore should not be construed as being limiting in any way.

From operation 304, the method 300 can proceed to operation 306. At operation 306, the computing device 102 can train one or more models. According to various embodiments, as illustrated and described above with reference to FIG. 1, the training module 108 can train, in some embodiments, a model of one or more devices of a cellular network 104 such as one or more cells 126 and therefore, operation 306 can include the training module 108 generating one or more cell fingerprints 136. The cell fingerprints 136 can model behavior of one or more components of the cellular network 104. It should be understood that this example is illustrative, and therefore should not be construed as being limiting in any way.

Additionally, or alternatively, as illustrated and described above with reference to FIG. 1, the training module 108 can train, in some embodiments, a model of one or more devices connecting to the cellular network 104 such as, for example, one or more user equipment 128, one or more Internet-of-things devices 130, and/or other devices. As such, operation 306 also can include the training module 108 generating one or more device fingerprints 138. The device fingerprints 138 can model behavior of one or more devices such as the user equipment 128, the Internet-of-things devices 130, and/or other devices that may connect to the cellular network 104. It should be understood that this example is illustrative, and therefore should not be construed as being limiting in any way.

From operation 306, the method 300 can proceed to operation 308. At operation 308, the computing device 102 can output the models trained in operation 306. Thus, operation 308 can correspond to the computing device 102 storing the models and/or providing the models to one or more other entities. As illustrated in the embodiment shown in FIG. 1, operation 308 can correspond to the computing device 102 storing the cell fingerprints 136 and/or the device fingerprints 138 at the computing device 102. It should be understood that this example is illustrative, and therefore should not be construed as being limiting in any way.

From operation 308, the method 300 can proceed to operation 310. The method 300 can end at operation 310.

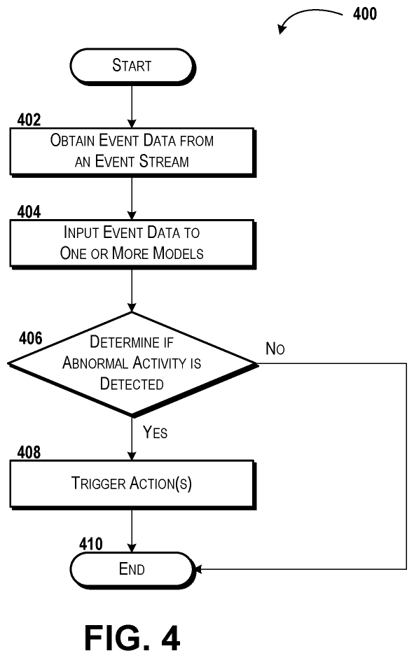

Turning now to FIG. 4, aspects of a method 400 for using event data 114 and one or more models such as the cell fingerprints 136, the device fingerprints 138, the device reputations 140, and/or the certification data 142 to detect abnormal activity in a cellular network 104 will be described in detail, according to an illustrative embodiment. For purposes of illustrating and describing the concepts of the present disclosure, the method 400 is described herein as being performed by the computing device 102 via execution of one or more software modules such as, for example, the data collection module 116, the production module 110, and/or the notification and action module 112. It should be understood that additional and/or alternative devices and/or network nodes can provide the functionality described herein via execution of one or more modules, applications, and/or other software including, but not limited to, the data collection module 116, the production module 110, and/or the notification and action module 112. Thus, the illustrated embodiments are illustrative, and should not be viewed as being limiting in any way.

The method 400 begins at operation 402. At operation 402, the computing device 102 can obtain event data 114 from an event stream 118. Although not illustrated separately in FIG. 4, it can be appreciated that the method 400 can include the data collection module 116 receiving the event stream 118, generating the event data 114 based on the event stream 118 and/or data included in the event stream 118, and providing the event data 114 to the network data analytic function 106. As such, operation 402 can include these and/or other operations, in addition to the network data analytic function 106 obtaining the event data 114. As noted above, the event data 114 can describe one or more events associated with the cellular network 104 and therefore can describe events associated with devices connecting to the cellular network 104 (e.g., the user equipment 128 and/or the Internet-of-things devices 130), various devices of the cellular network 104 (e.g., the cells 126), and/or other events as illustrated and described herein. Because the event data 114 can describe additional and/or alternative conditions associated with the cellular network 104 and/or devices communicating therewith and/or thereby, it should be understood that these examples are illustrative, and therefore should not be construed as being limiting in any way.

From operation 402, the method 400 can proceed to operation 404. At operation 404, the computing device 102 can input the event data 114 to one or more models such as, for example, the cell fingerprints 136, the device fingerprints 138, the device reputations 140, and/or the certification data 142. Thus, it can be appreciated that operation 404 can correspond to the computing device 102 inputting the event data 114 to the one or more statistical models that can correspond to the cell fingerprints 136, the device fingerprints 138, the device reputations 140, and/or the certification data 142 to predict or project behavior associated with the cellular network 104 and/or a device connected thereto such as the user equipment 128, the Internet-of-things device 130, and/or other devices. It can be appreciated that the machine learning models associated with the cell fingerprints 136, the device fingerprints 138, the device reputations 140, and/or the certification data 142 can, by inputting the event data 114, determine if an event associated with the event data 114 corresponds to abnormal activity of a device associated with the cellular network 104 (e.g., the cell 126) and/or a device connecting to and/or communicating with the cellular network 104 (e.g., the user equipment 128, the Internet-of-things device 130, or the like).

From operation 404, the method 400 can proceed to operation 406. At operation 406, the computing device 102 can determine if abnormal activity is detected. Thus, operation 406 can correspond to the computing device 102 determining if output from the one or more models (e.g., the cell fingerprints 136, the device fingerprints 138, the device reputations 140, and/or the certification data 142) that results from inputting the event data 114 corresponds to activity that is projected or expected to be abnormal.

If the computing device 102 determines, in operation 406, that the abnormal activity is detected in operation 406, the method 400 can proceed to operation 408. At operation 408, the computing device 102 can trigger an action. According to various embodiments, operation 408 can correspond to the computing device 102 generating output 144 such as, for example, one or more reports, one or more commands, combinations thereof, or the like, and providing the output 144 to one or more devices. In some embodiments, the output 144 can include one or more reports of abnormal activity associated with the cellular network 104.

The reports (or other embodiments of the output 144) can be provided to one or more devices such as, for example, an operator device 146. The operator device 146 can be associated with a network operator, security personnel, or the like, in some embodiments, and the output 144 therefore can be provided to the operator device 146 to inform security personnel or other entities of abnormal activity to enable tracking and/or resolution of events that may trigger responses, predictions of probably security concerns (e.g., an expected future security event and/or an existing buildup to such an attack), or the like. The reports can include information that can be used to identify the abnormal activity, the abnormally acting entity (e.g., user or device), and various aspects of the abnormal activity, as noted above and illustrated in FIG. 1.

In some embodiments of the concepts and technologies disclosed herein, operation 408 can correspond to providing commands or other forms of output 144 to a management entity or other entity such as a controller or the like associated with the cellular network 104 (e.g., the network management entity 148). The output 144 can trigger the network management entity 148 in some embodiments to make changes to one or more operational aspects of the cellular network 104, for example, to stop or contain the abnormal activity.

Thus, operation 408 can correspond to the computing device 102 providing the output 144 to the network management entity 148 and/or other devices to enable resolution by one or more entities of the cellular network 104. Because other actions can be triggered (e.g., delivering alerts to users or other entities, disconnecting devices such as the user equipment 128 and/or Internet-of-things devices 130 from the cellular network 104, deactivating network hardware such as the cells 126, or the like), it should be understood that these examples are illustrative, and therefore should not be construed as being limiting in any way.

From operation 408, the method 400 can proceed to operation 410. The method 400 also can proceed to operation 410 if the computing device 102 determines, in operation 406, that no abnormal activity is detected. The method 400 can end at operation 410.

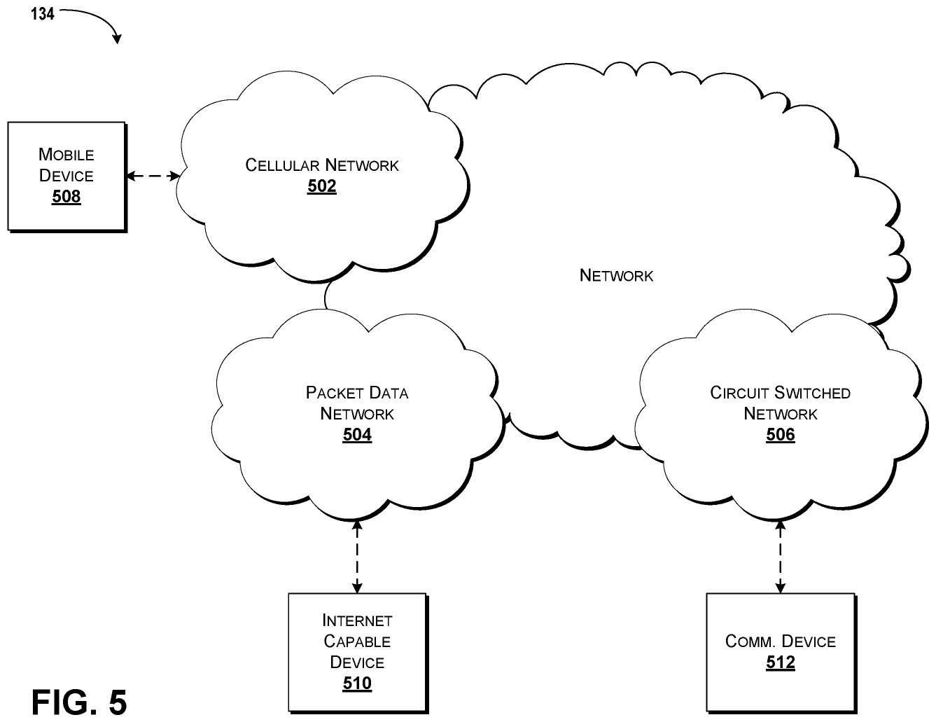

Turning now to FIG. 5, additional details of the network 134 are illustrated, according to an illustrative embodiment. The network 134 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), Node-B′s or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506. In some embodiments of the concepts and technologies disclosed herein, the functionality of the cellular network 502 can be provided by the cellular network 104 illustrated and described herein. It should be understood that this example is illustrative, and therefore should not be construed as being limiting in any way.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSDPA), and HSPA+. The cellular network 502 also is compatible with 4G mobile communications standards as well as evolved and future mobile standards.

The packet data network 504 includes various devices, for example, servers, computers, databases, and other devices in communication with one another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 134 is used to refer broadly to any combination of the networks 502, 504, 506. It should be appreciated that substantially all of the functionality described with reference to the network 134 can be performed by the cellular network 502, the packet data network 504, and/or the circuit switched network 506, alone or in combination with other networks, network elements, and the like.

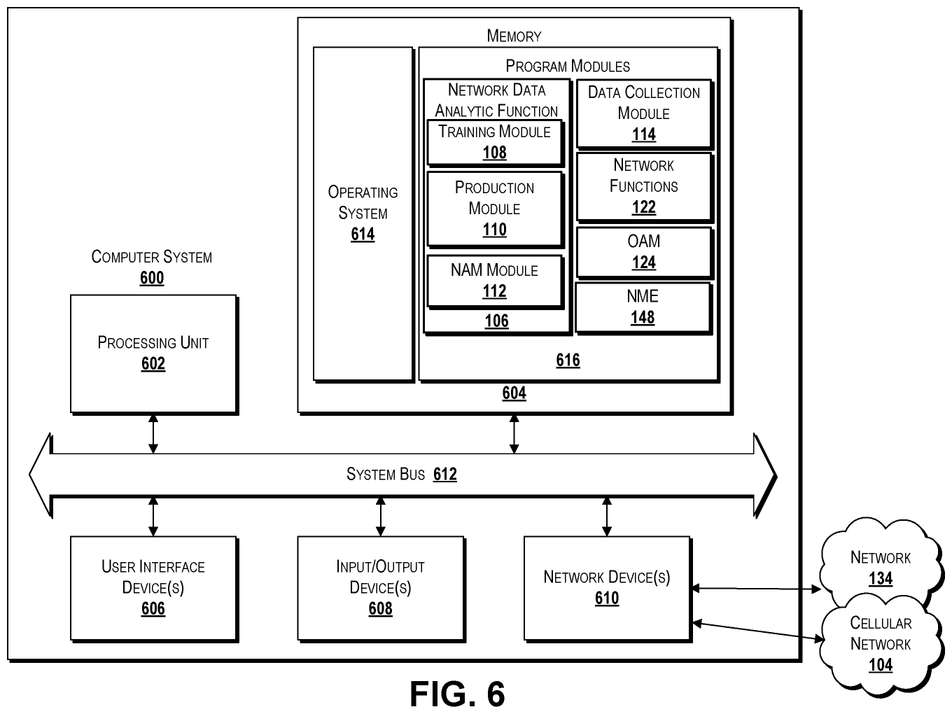

FIG. 6 is a block diagram illustrating a computer system 600 configured to provide the functionality described herein for providing network security using a network data analytic function, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 can include the network data analytic function 106, the training module 108, the production module 110, the notification and action module 112, the data collection module 116, the network functions 122, the operation, administration, and maintenance function 124, network management entity 148, and/or other modules. These and/or other programs can be embodied in computer-readable media containing instructions that, when executed by the processing unit 602, perform one or more of the methods 200, 300, and/or 400 described in detail above with respect to FIGS. 2-4 and/or other functionality as illustrated and described herein.

It can be appreciated that, at least by virtue of the instructions embodying the methods 200, 300, and/or 400, and/or other functionality illustrated and described herein being stored in the memory 604 and/or accessed and/or executed by the processing unit 602, the computer system 600 is a special-purpose computing system that can facilitate providing the functionality illustrated and described herein. According to embodiments, the program modules 616 may be embodied in hardware, software, firmware, or any combination thereof. Although not shown in FIG. 6, it should be understood that the memory 604 also can be configured to store the event stream 118, the event data 114, the cell fingerprints 136, the device fingerprints 138, the device reputations 140, the certification data 142, the output 144, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 134 and/or the cellular network 104. Examples of the network devices 610 include, but are not limited to, a modem, a radio frequency (“RF”) or infrared (“IR”) transceiver, a telephonic interface, a bridge, a router, or a network card. The network 134 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 134 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

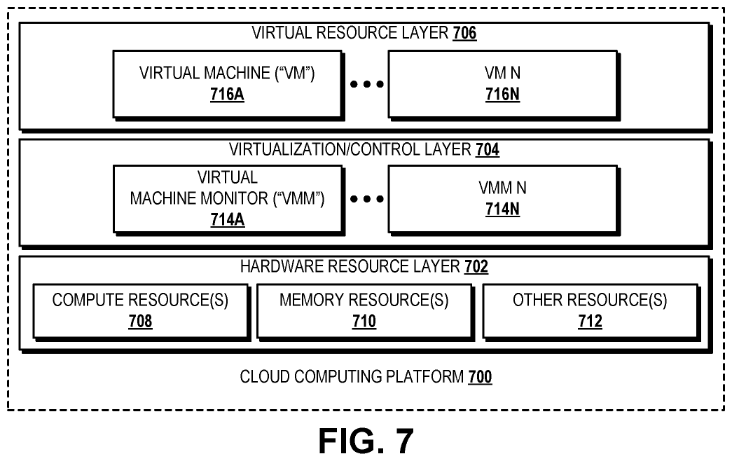

FIG. 7 illustrates an illustrative architecture for a cloud computing platform 700 that can be capable of executing the software components described herein for providing network security using a network data analytic function and/or for interacting with the network data analytic function 106, the training module 108, the production module 110, the notification and action module 112, the data collection module 116, the network functions 122, the operation, administration, and maintenance function 124, network management entity 148, and/or other modules as illustrated and described herein. Thus, it can be appreciated that in some embodiments of the concepts and technologies disclosed herein, the embodiment of the cloud computing platform 700 illustrated in FIG. 7 can be used to provide the functionality described herein with respect to the computing device 102, the core 120, the cellular network 104, or other devices illustrated and described herein.

The cloud computing platform 700 thus may be utilized to execute any aspects of the software components presented herein. Thus, according to various embodiments of the concepts and technologies disclosed herein, the network data analytic function 106, the training module 108, the production module 110, the notification and action module 112, the data collection module 116, the network functions 122, the operation, administration, and maintenance function 124, network management entity 148, and/or other modules can be implemented, at least in part, on or by elements included in the cloud computing platform 700 illustrated and described herein. Those skilled in the art will appreciate that the illustrated cloud computing platform 700 is a simplification of but only one possible implementation of an illustrative cloud computing platform, and as such, the illustrated cloud computing platform 700 should not be construed as being limiting in any way.

In the illustrated embodiment, the cloud computing platform 700 can include a hardware resource layer 702, a virtualization/control layer 704, and a virtual resource layer 706. These layers and/or other layers can be configured to cooperate with each other and/or other elements of a cloud computing platform 700 to perform operations as will be described in detail herein. While connections are shown between some of the components illustrated in FIG. 7, it should be understood that some, none, or all of the components illustrated in FIG. 7 can be configured to interact with one another to carry out various functions described herein. In some embodiments, the components are arranged so as to communicate via one or more networks such as, for example, the network 134 illustrated and described hereinabove (not shown in FIG. 7). Thus, it should be understood that FIG. 7 and the following description are intended to provide a general understanding of a suitable environment in which various aspects of embodiments can be implemented, and should not be construed as being limiting in any way.

The hardware resource layer 702 can provide hardware resources. In the illustrated embodiment, the hardware resources can include one or more compute resources 708, one or more memory resources 710, and one or more other resources 712. The compute resource(s) 708 can include one or more hardware components that can perform computations to process data, and/or to execute computer-executable instructions of one or more application programs, operating systems, services, and/or other software including, but not limited to, the network data analytic function 106, the training module 108, the production module 110, the notification and action module 112, the data collection module 116, the network functions 122, the operation, administration, and maintenance function 124, network management entity 148, and/or other modules illustrated and described herein.

According to various embodiments, the compute resources 708 can include one or more central processing units (“CPUs”). The CPUs can be configured with one or more processing cores. In some embodiments, the compute resources 708 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 708 can include one or more discrete GPUs. In some other embodiments, the compute resources 708 can include one or more CPU and/or GPU components that can be configured in accordance with a co-processing CPU/GPU computing model. Thus, it can be appreciated that in some embodiments of the compute resources 708, a sequential part of an application can execute on a CPU and a computationally-intensive part of the application can be accelerated by the GPU. It should be understood that this example is illustrative, and therefore should not be construed as being limiting in any way.

In some embodiments, the compute resources 708 also can include one or more system on a chip (“SoC”) components. It should be understood that the SoC component can operate in association with one or more other components as illustrated and described herein, for example, one or more of the memory resources 710 and/or one or more of the other resources 712. In some embodiments in which an SoC component is included, the compute resources 708 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Tex.; one or more customized versions of any of the above SoCs; and/or one or more other brand and/or one or more proprietary SoCs.

The compute resources 708 can be or can include one or more hardware components arranged in accordance with an ARM architecture, available for license from ARM HOLDINGS of Cambridge, United Kingdom. Alternatively, the compute resources 708 can be or can include one or more hardware components arranged in accordance with an x86 architecture, such as an architecture available from INTEL CORPORATION of Mountain View, Calif., and others. Those skilled in the art will appreciate the implementation of the compute resources 708 can utilize various computation architectures and/or processing architectures. As such, the various example embodiments of the compute resources 708 as mentioned hereinabove should not be construed as being limiting in any way. Rather, implementations of embodiments of the concepts and technologies disclosed herein can be implemented using compute resources 708 having any of the particular computation architecture and/or combination of computation architectures mentioned herein as well as other architectures.

Although not separately illustrated in FIG. 7, it should be understood that the compute resources 708 illustrated and described herein can host and/or execute various services, applications, portals, and/or other functionality illustrated and described herein. Thus, the compute resources 708 can host and/or can execute the network data analytic function 106, the training module 108, the production module 110, the notification and action module 112, the data collection module 116, the network functions 122, the operation, administration, and maintenance function 124, network management entity 148, and/or other modules or other applications or services illustrated and described herein.

The memory resource(s) 710 can include one or more hardware components that can perform or provide storage operations, including temporary and/or permanent storage operations. In some embodiments, the memory resource(s) 710 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 708, subject to the definition of “computer storage media” provided above (e.g., as excluding waves and signals per se and/or communication media as defined in this application).

Although not illustrated in FIG. 7, it should be understood that the memory resources 710 can host or store the various data illustrated and described herein including, but not limited to, the event stream 118, the event data 114, the cell fingerprints 136, the device fingerprints 138, the device reputations 140, the certification data 142, the output 144, and/or other data, if desired. It should be understood that this example is illustrative, and therefore should not be construed as being limiting in any way.

The other resource(s) 712 can include any other hardware resources that can be utilized by the compute resources(s) 708 and/or the memory resource(s) 710 to perform operations. The other resource(s) 712 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 702 can be virtualized by one or more virtual machine monitors (“VMMs”) 714A-714N (also known as “hypervisors;” hereinafter “VMMs 714”). The VMMs 714 can operate within the virtualization/control layer 704 to manage one or more virtual resources that can reside in the virtual resource layer 706. The VMMs 714 can be or can include software, firmware, and/or hardware that alone or in combination with other software, firmware, and/or hardware, can manage one or more virtual resources operating within the virtual resource layer 706.

The virtual resources operating within the virtual resource layer 706 can include abstractions of at least a portion of the compute resources 708, the memory resources 710, the other resources 712, or any combination thereof. These abstractions are referred to herein as virtual machines (“VMs”). In the illustrated embodiment, the virtual resource layer 706 includes VMs 716A-716N (hereinafter “VMs 716”).

Based on the foregoing, it should be appreciated that systems and methods for providing network security using a network data analytic function have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
obtaining, at a computing device that executes a network data analytic function, event data based on an event stream, the event data representing events on a cellular network;
providing, to a training module, the event data;
training, using the training module, a plurality of models associated with the cellular network, wherein the plurality of models comprises a cell fingerprint and a device fingerprint, wherein the cell fingerprint comprises a statistical model of a cell of the cellular network, and wherein the device fingerprint comprises a statistical model of a device that connected to the cellular network; and
outputting the plurality of models.

2. The system of claim 1, wherein the computer-executable instructions, when executed by the processor, cause the processor to perform operations further comprising:
splitting, using a data collection module, the event stream into a first portion of the event data and a second portion of the event data, wherein providing the event data to the training module comprises providing the first portion of the event data to the training module; and
providing, to a production module, the second portion of the event data.

3. The system of claim 1, wherein the computer-executable instructions, when executed by the processor, cause the processor to perform operations further comprising:
receiving a new instance of event data from the event stream;
providing, to a production module, the new instance of event data;
determining, by the production module and based on the new instance of event data and the plurality of models, if abnormal activity is detected in the cellular network, wherein the abnormal activity is associated with the device that connected to the cellular network or a network component of the cellular network; and
in response to determining that the abnormal activity is detected, triggering, using a notification and action module, an action.

4. The system of claim 3, wherein the action comprises:
generating, using the notification and action module, a command to remediate the abnormal activity; and
providing, using the notification and action module, the command to a network management entity of the cellular network to modify an operation of the cellular network.

5. The system of claim 3, wherein the action comprises:
generating, using the notification and action module, a report that represents the abnormal activity; and
providing, using the notification and action module, the report to an operator device.

6. A method comprising:
obtaining, at a computing device comprising a processor that executes a network data analytic function, event data based on an event stream, the event data representing events on a cellular network;
providing, by the processor and to a training module, the event data;
training, by the processor and using the training module, a plurality of models associated with the cellular network, wherein the plurality of models comprises a cell fingerprint and a device fingerprint, wherein the cell fingerprint comprises a statistical model of a cell of the cellular network, and wherein the device fingerprint comprises a statistical model of a device that connected to the cellular network; and
outputting, by the processor, the plurality of models.

7. The method of claim 6, wherein the device that connected to the cellular network comprises a user equipment that connected to the cell of the cellular network.

8. The method of claim 6, wherein the device that connected to the cellular network comprises an Internet-of-things device that connected to the cellular network via a customer premises equipment that communicates with the cellular network via a network connection.

9. The method of claim 6, wherein the event stream is received from a network function that operates in a core of the cellular network, the network function comprising a 5G core access and mobility management function or a 5G session management function.

10. The method of claim 6, wherein the event stream is received from an operation, administration, and maintenance function that operates in a core of the cellular network.

11. The method of claim 6, further comprising:
splitting, by the processor and using a data collection module, the event stream into a first portion of the event data and a second portion of the event data, wherein providing the event data to the training module comprises providing the first portion of the event data to the training module; and
providing, by the processor and to a production module, the second portion of the event data.

12. The method of claim 6, further comprising:
receiving, by the computing device, a new instance of event data from the event stream;
providing, by the processor and to a production module, the new instance of event data;
determining, by the production module and based on the new instance of event data and the plurality of models, if abnormal activity is detected in the cellular network, wherein the abnormal activity is associated with the device that connected to the cellular network or a network component of the cellular network; and
in response to determining that the abnormal activity is detected, triggering, by the processor and using a notification and action module, an action.

13. The method of claim 12, wherein the action comprises:
generating, by the processor and using the notification and action module, a command to remediate the abnormal activity; and
providing, by the processor and using the notification and action module, the command to a network management entity of the cellular network to modify an operation of the cellular network.

14. The method of claim 12, wherein the action comprises:
generating, by the processor and using the notification and action module, a report that represents the abnormal activity; and
providing, by the processor and using the notification and action module, the report to an operator device.

15. A computer storage medium having computer-executable instructions stored thereon that, when executed by a processor, cause the processor to perform operations comprising:
obtaining, at a computing device that executes a network data analytic function, event data based on an event stream, the event data representing events on a cellular network;
providing, to a training module, the event data;
training, using the training module, a plurality of models associated with the cellular network, wherein the plurality of models comprises a cell fingerprint and a device fingerprint, wherein the cell fingerprint comprises a statistical model of a cell of the cellular network, and wherein the device fingerprint comprises a statistical model of a device that connected to the cellular network; and
outputting the plurality of models.

16. The computer storage medium of claim 15, wherein the computer-executable instructions, when executed by the processor, cause the processor to perform operations further comprising:
splitting, using a data collection module, the event stream into a first portion of the event data and a second portion of the event data, wherein providing the event data to the training module comprises providing the first portion of the event data to the training module; and
providing, to a production module, the second portion of the event data.

17. The computer storage medium of claim 15, wherein the computer-executable instructions, when executed by the processor, cause the processor to perform operations further comprising:
receiving a new instance of event data from the event stream;
providing, to a production module, the new instance of event data;
determining, by the production module and based on the new instance of event data and the plurality of models, if abnormal activity is detected in the cellular network, wherein the abnormal activity is associated with the device that connected to the cellular network or a network component of the cellular network; and
in response to determining that the abnormal activity is detected, triggering, using a notification and action module, an action.

18. The computer storage medium of claim 17, wherein the action comprises:
generating, using the notification and action module, a command to remediate the abnormal activity; and
providing, using the notification and action module, the command to a network management entity of the cellular network to modify an operation of the cellular network.

19. The computer storage medium of claim 17, wherein the action comprises:
generating, using the notification and action module, a report that represents the abnormal activity; and
providing, using the notification and action module, the report to an operator device.

20. The computer storage medium of claim 15, wherein the event stream is received from a network function that operates in a core of the cellular network, the network function comprising a 5G core access and mobility management function or a 5G session management function.
